(19) United States
(12) Patent Application Publication
(10) Pub. No.: US 2011/0286870 A1
(43) Pub. Date: Nov. 24, 2011

(54) System and Method for Holding Tubing for a Peristaltic Pump that Prevents Tubing Stretch or Deformation

(76) Inventor: David Bach, Bedford, NH (US)

(21) Appl. No.: 13/114,266

(22) Filed: May 24, 2011

Related U.S. Application Data
(60) Provisional application No. 61/396,049, filed on May 24, 2010.

(51) Int. Cl. F04B 43/08; B23P 17/00

(52) U.S. Cl. 417/474; 29/888

(57) ABSTRACT

An enhancement for a peristaltic pump that, in a particular embodiment, can be a thin concave spring member or other mechanism with at least one tubing notch adapted to be mounted on a peristaltic pump frame such that peristaltic pump tubing can pass through a notch in the spring member, through the peristaltic pump and through a notch in a similar thin concave spring member mounted on an opposite side of said peristaltic pump so that the spring members prevent tube-stretching or deformation of the tubing. Numerous other embodiments are possible. All of the embodiments allow attaching a first and second notched spring-clamp or other tubing holder onto the input and output sides of a peristaltic pump frame; threading peristaltic pump tubing through a notch or other part in a first spring-clamp or tubing holder, through the peristaltic pump and through a notch or other part in a second spring-clamp or tubing holder.

This application is related to and claims priority from U.S. Provisional Patent Application No. 61/396,049 filed May 24, 2010. Application 61/396,049 is hereby incorporated by reference.

### BACKGROUND

1. Field of the Invention

The present invention relates generally to peristaltic pumps used in the bio-sciences and more particular to a system and method for holding tubing for a peristaltic pump the prevents tubing stretch or deformation.

2. Description of the Prior Art

Fluid dispensing in the pharmaceutical and other markets such as biotechnology are moving away from positive piston pumps and moving to peristaltic pump systems. The main driving force is that peristaltic pump systems do not create shear in the fluid being pumped, and the cleaning validation is simplified as compared to positive piston displacement systems. In sealless positive displacement pumps, it has been demonstrated that the fluid experiences shear forces that have an adverse effect on delicate cell structures.

Peristaltic pumps use a series of rollers to compress tubing that passes through the pump to move a fluid. There are many companies that make peristaltic pumps such as Watson-Marlow, Flexicon and Masterfiex, and they all use the same principle of compressing tubing to advance fluid. It has been demonstrated in numerous studies that the use of a peristaltic pump allows for the effective handling of protein and cell structures without the shear forces of piston pumps. Peristaltic pumps have a fluid path only consisting of the tubing that can easily be sterilized, and in many cases discarded after use. This makes the cleaning validation much simpler and reliable.

As peristaltic pumps are being used more for various products, there is a need to carefully support and control the tubing that is being used in the pump Peristaltic pump tubing needs to be held at the input to the peristaltic pump so that when the tubing is compressed it does not advance into the pump. Some manufacturers such as Watson-Marlow and others use tubing clamps and a Y-structure that is must be carefully inserted around two fixed posts, one post being at the input and the other at the output. When such tubing clamps are used, they can have a negative effect of restricting the flow due to sizing or if tightened too much. There are a number of attachment devices known in the art designed to secure and hold tubing, but none of the systems provides for tubing elongation when the peristaltic pump is exercised. Action of the pump can force the tubing to elongate in the direction of rotation. This can be seen in the field where the Y is stretched around the two fixed posts at before running, but after running, the tubing is loose at the output post. If individual tubes holders are used, the output clamp will exhibit a loose-tube condition present as the tube stretches during use. In some units such as the Colanar peristaltic pump FSP-1001, the rollers are geared so that the forward stretching is less than in non-geared systems; nevertheless, elongation still takes place. Tubing stretch occurs in all peristaltic pump systems, and none of the systems currently known in the art have a way of compensating for this stretch. Many of the systems offer a drip retention or suck-back feature where the rollers in the pump are reversed at the end of a pump run in order to move the fluid back into the output tubing. In these cases, drip retention is part of the relaxing of the tube elongation and movement of fluid back into the tube. Tube stretching and relaxing leads to a loss of accuracy since it has the effect of causing variability in each fill.

It would be advantageous to have a system and method of holding the tubing in a peristaltic pump where the input side is held fixed, but there is no restriction introduced into the fluid passage. Also, the output part of the system needs to compensate for tube elongation.

### SUMMARY OF THE INVENTION

The present invention relates to an enhancement for a peristaltic pump that, in a particular embodiment, can be a thin concave spring member or other mechanism with at least one tubing notch adapted to be mounted on a peristaltic pump frame such that peristaltic pump tubing can pass through a notch in the spring member, through the peristaltic pump and through a notch in a similar thin concave spring member mounted on an opposite side of said peristaltic pump so that the spring members prevent tube-stretching or deformation of the tubing. Numerous other embodiments are possible. All of the embodiments of the present invention allow attaching a first and second notched spring-clamp or other tubing holder on the input and output sides of a peristaltic pump frame; threading peristaltic pump tubing through a notch or other part in a first spring-clamp or tubing holder, through the peristaltic pump and through a notch or other part in a second spring-clamp or tubing holder. Generally the spring members are spring steel, but any rigid, partially elastic material can be used. In some embodiments of the invention, the peristaltic pump tubing changes diameter near the tubing holders. A common way of having the tubing holders hold the tubing is to use spring members that each contain one or more notches. The present invention can accommodate from 1 to n tubes, where n is a positive integer.

### DESCRIPTION OF THE FIGURES

Illustrations are now presented to aid in understanding features of the present invention:

FIG. 1 shows a prior art peristaltic pump.

FIG. 2 shows an embodiment of the present invention attached to the pump of FIG. 1

FIG. 3 shows the embodiment of FIG. 2 with tubing installed.

Several drawings and illustrations have been presented. The scope of the present invention is not limited to what is shown in the figures.

### DESCRIPTION OF THE INVENTION

The present invention relates to a spring loaded input and output tube holder for peristaltic pump tubing that will provide a tension while holding the tubing in an elongated position. The tube holder provides for a constant tension and can also have a ratchet mechanism so that the tubing can not slip backward. The invention allows for from one to n tubes to be placed in a peristaltic pump, be properly supported at the input side, and each tube being able to go straight through the peristaltic pump. The tubing in a Watson-Marlow Y-configuration does not go through the pump in a straight fashion; this can result in excessive tubing wear. The present invention cures this problem. The output side has a tube holder providing constant tension, with or without a ratchet mechanism, and is aligned so that each tube runs straight through the peristaltic pump. The tension device can be designed for single tube or multiple tube tensioning. The initial tension in the output device can be as low as zero where the tubing elongation itself provides the necessary force through a non-reversing output tube holding mechanism.

There is a progression of rollers that takes place during sequential dispensing with a typical peristaltic pump. When the release roller is not at the exit of the shoe, the amount of material flow-back can increase. If on the other hand the roller is at the exact exit of the shoe compression when the end of a cycle occurs, the amount of material flow-back is at a minimum. If the rollers are at the earliest point in the shoe compression when the cycle is ended, the elongation will cause flow-back to be maximum. This change in elongation results in variability in the dispensing results. If suck-back or drip-retention is used, this effect is much greater. The tension provided by the present invention, with or without a ratchet-forward device, solves this problem by not allowing excess extension of material to flow back to the rollers when the pump is stopped.

The present invention includes a fixed input holder and an output holder that provide a tension to the output tube. In a particular embodiment, tension is created when the tubing is moved forward through the output holder by its own elongation which is not allowed to reverse. There are various embodiments of the input and output holders that are within the scope of the present invention, but they need to have a mechanism that keeps the tube(s) in tension relative to the output rollers. When a suck-back cycle is used, the tension device of the present invention holds the tubing from moving back toward the pump rollers. Particular embodiments of the tension device of the invention can optionally have a ratchet mechanism that stops the tubing from moving backwards toward the peristaltic rollers. Another embodiment is where a gear type device is used with the tubes where, on the input side they are locked, and on the output side, they can allow the tube to move through the gears but not to move back due to the non-reversing of the output mechanism.

In various embodiments of the invention, tubing can be added so that the input and/or output can have a Y-connector that is not under stress. Also, the tubing can be single individual tubes or can be combined with tubing of a different diameter after the holders. For example, ¼ inch tube as an OD of 5/16 inch onto which 5/16 ID tubing can be bonded at a fixed distance between the two stops.

The tube holder of the present invention can be made of spring material so that the slots can be on cantilevered on spring stainless steel or equivalent material. While any rigid, elastic material can be used, but spring stainless steel is preferred.

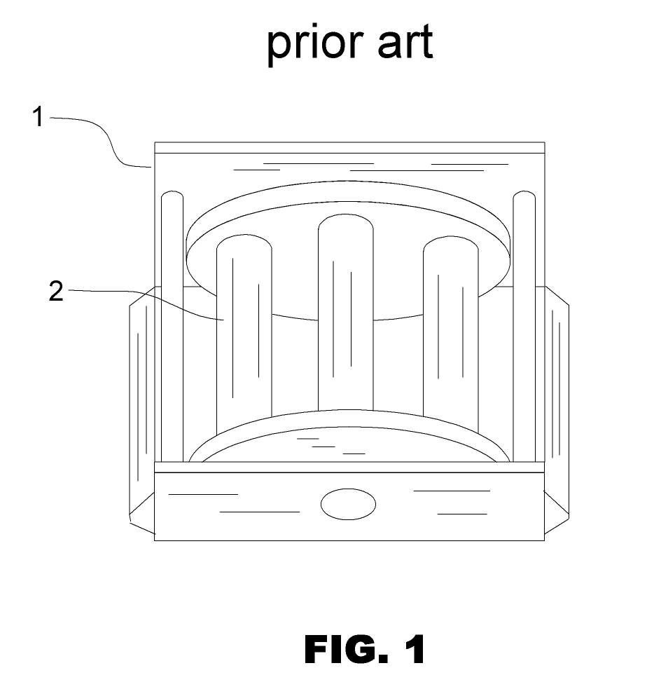

Turning to FIG. 1, a prior art peristaltic pump can be seen in a top-down perspective view. The pump body 1 supports a series of rollers 2 through which tubing is threaded. Successive compression of the tubing between the rollers 2 and a shoe cause fluid to be pumped through the device.

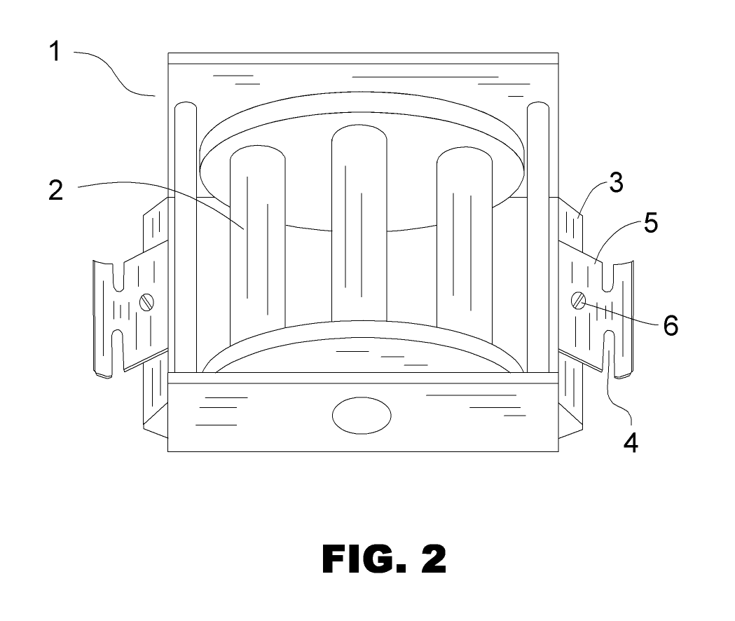

FIG. 2 shows an embodiment of the present invention in the pump of FIG. 1 without any tubing. A spring steel tube holder 5 can be installed on part 3 of the frame at both the input and output sides of the pump. FIG. 2 shows installation with a screw 6; however, any fastening means is within the scope of the present invention. The tube holder 5 can have a elongated slot 4 on each side for, in this case, two tubes. The tube-holder 5 can be concave upward in a preferred configuration; however, any other configuration is within the scope of the present invention. Embodiments of the present invention can have one, or any number of slots or other holding means for any number of tubes.

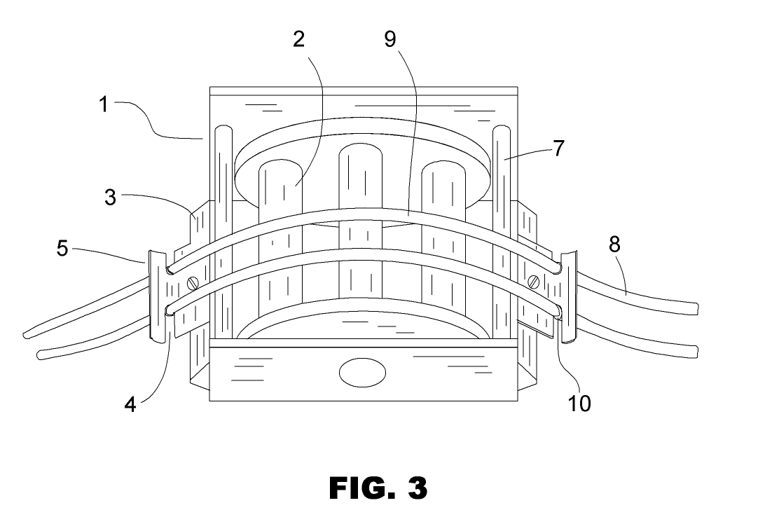

FIG. 3 shows the embodiment of FIG. 2 with two tubes 8 installed. In this particular example, a larger tube 8 has been inserted 10 over a smaller tube 9 at the slot 4 in the holder 5. This is completely optional and for convenience. Single tubes of constant OD, or any number of tube size changes are within the scope of the present invention. In any case, the input and output tube holders 5 function as previously described to cause an tremendous increase in the performance and accuracy of the peristaltic pump.

A tube holder has been designed that easily holds peristaltic tubing without reducing the tube ID and can use a small or longer section of a second tube that can be bonded to the outside diameter of the pump tube. These tubes allow the peristaltic tube to be easily loaded into the pump and can be used with the tension devices. The present invention provides a spring loaded input and output tube holder for peristaltic pump tubing that will provide a tension while holding the tubing in an elongated position. The tube holder provides for a constant tension on the tubing without allowing a backward slipping.

Several descriptions an illustrations have been provided to aid in understanding the present invention. One of skill in the art will realize that numerous changes and variations are possible without departing from the spirit of the invention. Each of these changes and variations is within the scope of the present invention.

I claim:

1. A method for preventing tube-stretching or deformation on a peristaltic pump comprising:
attaching a first and second notched spring-clamp on the input and output sides of a peristaltic pump frame;
threading peristaltic pump tubing through a notch in said first notched spring-clamp, through said peristaltic pump and through a notch in said second notched spring-clamp.

2. The method of claim 1 wherein said first and second notched spring-clamps are spring stainless steel.

3. The method of claim 1 wherein said peristaltic pump tubing changes diameter near said first and second spring-clamps.

4. The method of claim 1 wherein said first and second spring-clamps are concave upward when mounted on said peristaltic pump frame.

5. The method of claim 1 wherein said first and second spring-clamps each contain a plurality of notches.

6. The method of claim 1 wherein said first and second spring-clamps each have two notches.

7. A method for preventing tube-stretching or deformation on a peristaltic pump comprising:
providing a first and second notched spring-clamp adapted to be attached onto the input and output sides of a peristaltic pump frame;
allowing peristaltic pump tubing to be threaded through a notch in said first notched spring-clamp, through said peristaltic pump and through a notch in said second notched spring-clamp.

8. The method of claim 7 wherein said first and second notched spring-clamps are spring stainless steel.

9. The method of claim 7 wherein said peristaltic pump tubing changes diameter near said first and second spring-clamps.

10. The method of claim 7 wherein said first and second spring-clamps are concave upward when mounted on said peristaltic pump frame.

11. The method of claim 7 wherein said first and second spring-clamps each contain a plurality of notches.

12. The method of claim 7 wherein said first and second spring-clamps each have two notches.

13. An enhancement for a peristaltic pump comprising:
a thin concave spring member with at least one tubing notch adapted to be mounted on a peristaltic pump frame such that peristaltic pump tubing can pass through the notch in said spring member, through said peristaltic pump and through a notch in a similar thin concave spring member mounted on an opposite side of said peristaltic pump whereby said spring members prevent tube-stretching or deformation of said tubing.

14. The enhancement of claim 13 wherein said spring members are spring stainless steel.

15. The enhancement of claim 13 wherein said peristaltic pump tubing changes diameter near said spring members.

16. The enhancement of claim 13 wherein said spring members each contain a plurality of notches.

17. The enhancement of claim 13 wherein said first and second spring-clamps each contain two notches.
